(19) United States
(12) Patent Application Publication
(10) Pub. No.: US 2008/0296215 A1
(43) Pub. Date: Dec. 4, 2008

(54) WASTEWATER TREATMENT AND DISPOSAL SYSTEM

(76) Inventor: Daniel F. Simon, Yreka, CA (US)

Correspondence Address: Zilka-Kotab, PC, P.O. Box 721120, San Jose, CA, 95172-1120, US

(21) Appl. No.: 12/129,517

(22) Filed: May 29, 2008

Related U.S. Application Data
(60) Provisional application No. 60/940,918, filed on May 30, 2007.

(51) Int. Cl. C02F 9/10; C02F 9/14; C02F 3/28; C02F 1/42; C02F 1/48; C02F 1/58

(52) U.S. Cl. 210/202; 210/198.1; 210/259; 204/664; 210/180; 210/255; 210/170.08

(57) ABSTRACT

A wastewater treatment system according to various embodiments of the present invention includes one or more of a settling tank for receiving wastewater; a mineral removal system receiving water from the settling tank, the mineral removal system being for removing at least some of the minerals from the water; and a vaporization system receiving water from the mineral removal system, the vaporization system being for vaporizing the water.

### RELATED APPLICATIONS

This application claims priority to U.S. Provisional Patent Application No. 60/940,918, filed May 30, 2007, which is herein incorporated by reference.

### FIELD OF THE INVENTION

The present invention relates to wastewater treatment, and more particularly, this invention relates to systems and methods for wastewater treatment and disposal.

### BACKGROUND OF THE INVENTION

In many cases regarding real property, sewage disposal is not possible due to factors including inadequate soils, septic system set backs, high groundwater, size and grade of parcel or lot, site unavailability of a public sewer, and other restrictions and limitations. Environmental Health Departments commonly have within their jurisdictions parcels and/or lots that fit one or more of the above descriptions. The Health Departments will not grant a septic water or sewage disposal permit for these parcels/lots. This in turn makes the land unsuitable for building purposes and therefore unusable for legal human occupancy. This may make the land legally useless, even with the use of existing technologies. Without a septic system permit, an occupiable building cannot be constructed. Typically, the Building Department requires a permit from the Health Department prior to granting a building permit. In rare cases, when a septic system fails, the home is “Red-Tagged,” and the occupants must leave the house because the septic system becomes a human health hazard, and may not be repairable.

Therefore, there is a current need for addressing these and other problems associated with sewage disposal.

### SUMMARY OF THE INVENTION

A wastewater treatment system according to one embodiment of the present invention includes a settling tank for receiving wastewater; a mineral removal system receiving water from the settling tank, the mineral removal system being for removing at least some of the minerals from the water; and a vaporization system receiving water from the mineral removal system, the vaporization system being for vaporizing the water.

A septic water treatment system according to another embodiment of the present invention includes a settling tank for receiving septic water; and a mineral removal system receiving water from the settling tank, the mineral removal system being for removing at least some of the minerals from the water.

A septic water treatment system according to yet another embodiment of the present invention includes a settling tank for receiving wastewater; and a vaporization system receiving water from the settling tank, the vaporization system being for vaporizing the water in the presence of a vacuum, the vacuum being at least 0.15 atmospheres below an air pressure of an environment located at an outlet of the vaporization system.

A method for controlling wastewater treatment according to yet another embodiment of the present invention includes monitoring a water level in an effluent tank; opening a solenoid or valve when the water level is above a predefined level; starting a vacuum pump coupled to an evaporation chamber; monitoring a water level in the evaporation chamber; closing the solenoid or valve when the water level in the evaporation chamber is above a predefined level; and stopping the vacuum pump when the water level in the evaporation chamber is below a predefined level.

A method for applying a wastewater treatment system to real estate according to yet another embodiment of the present invention includes obtaining a permit and regulatory approval for the construction of a modified septic system on restricted property; constructing a modified septic system on the property; and either performing one of selling, renting, or leasing the property with the modified septic system, or obtaining a building permit for the property; constructing a building on the property; obtaining a building occupancy permit for the building; performing at least one of selling, renting, or leasing the building; and maintaining the property.

A method of heating according to yet another embodiment of the present invention includes receiving treated wastewater; heating the treated wastewater; and directing the wastewater to a location where heat in the treated wastewater is used.

A method of converting energy according to yet another embodiment of the present invention includes receiving treated wastewater; heating the treated wastewater to a pressurized gaseous state; and converting energy in the pressurized gaseous wastewater to at least one of mechanical and electrical energy.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of a wastewater treatment system in accordance with one embodiment of the present invention.

FIG. 2 is a system diagram of a wastewater treatment system in accordance with another embodiment of the present invention.

FIG. 3 is a system diagram of a wastewater treatment system in accordance with another embodiment of the present invention.

FIG. 4 is a system diagram of a wastewater treatment system in accordance with another embodiment of the present invention.

FIG. 5A is a flow diagram of a method for applying a wastewater treatment system to the purchase of real estate.

FIG. 5B is a flow diagram of a method for applying a wastewater treatment system to permission to build on real estate.

FIG. 5C is a flow diagram of a method for applying a wastewater treatment system to real estate.

FIG. 6 is a flow diagram of a method for heating.

FIG. 7 is a system diagram of a system for heating.

FIG. 8 is a flow diagram of a method for converting energy.

FIG. 9 is a system diagram of a system which may be used in conjunction with the method of FIG. 8.

### BEST MODE FOR CARRYING OUT THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and as defined in dictionaries, treatises, etc.

In the drawings, like and equivalent elements are numbered the same throughout the various figures.

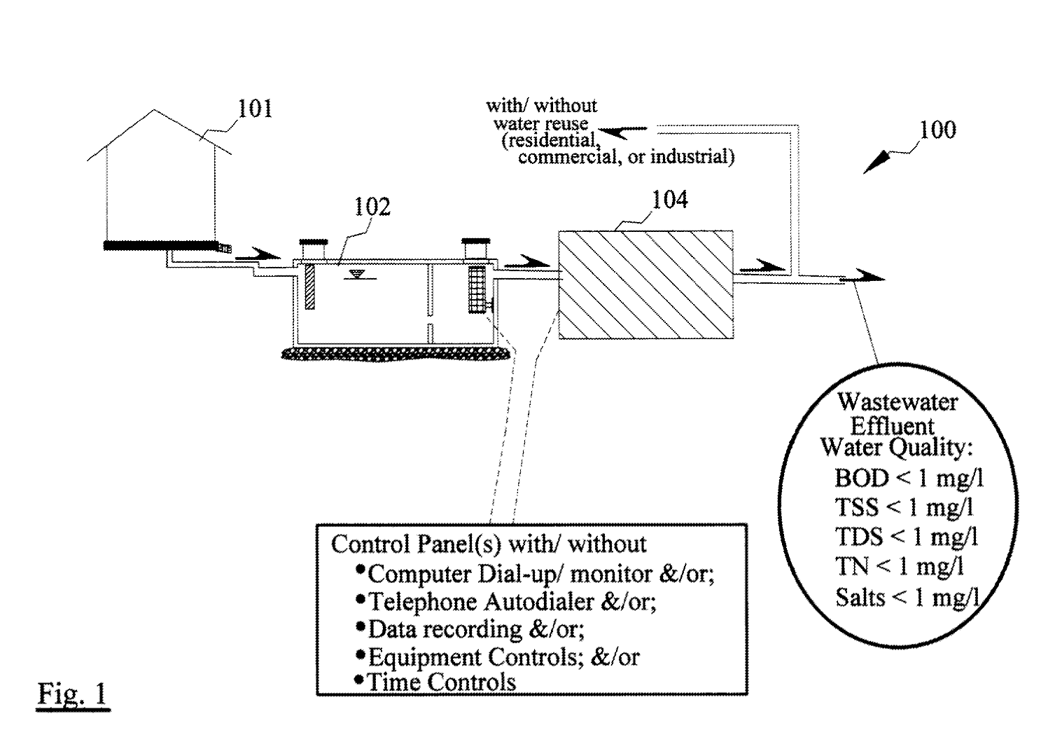

FIG. 1 illustrates a wastewater treatment system 100 in accordance with one embodiment of the present invention. As shown in FIG. 1, wastewater is received by a settling tank 102. The settling tank may comprise a traditional septic tank. In the context of the present description, wastewater may contain human excrement (e.g., feces and urine) and may be produced by occupants of a building 101. Such water is also known by those skilled in the art as septic water, sanitary wastewater, domestic wastewater, etc. Wastewater may also or alternatively contain some other contaminant such as a chemical, compound, etc. An example of the latter is commercial or industrial wastewater of various types. A building may include any structure fit for habitation, e.g. a single home, a multi-unit home, an office building, a municipality, etc. Amenities in the building 101 which contribute to wastewater production may include bathrooms, showers, tubs, toilets, dishwashers, washing machines, sinks, etc. A building 101 may also include a structure fit for habitation, such as a courthouse, portable toilet, etc.

In one embodiment, the settling tank 102 may receive the wastewater through an inlet pipe. The settling tank 102 may settle solids in the wastewater while allowing particles to float to the surface of the wastewater. The solids may be dissolved, suspended, settled, and/or floating in the wastewater. Further, in another embodiment, the settling tank 102 may discharge treated water containing minimal solids through an outlet pipe. The settling tank may also comprise an effluent filter for further filtration purposes.

Additionally, in another embodiment the settling tank 102 may contain at least one of microbes, e.g. bacteria, amoebas, etc., and enzymes for biologically treating the wastewater. The treatment may convert solids to gases and indigestible matter. The biological treatment of wastewater may occur anerobically, aerobically, anoxically, etc. This biological treatment may also be performed by a secondary treatment system which receives water from the settling tank 102 and utilizes biological decomposition, including the methods just described, to remove solids and constituents from the water.

In addition, treated water discharged from the settling tank 102 is received by a mineral removal system 104. Optionally, the water may be further treated, processed, pumped, etc. before it is directed to the mineral removal system 104. The mineral removal system 104 removes at least some of the minerals and/or organic matter from the water. In one embodiment, the mineral removal system 104 may provide further treatment of treated water through aerobic or anerobic treatment. The wastewater treatment system may include the use of one or more of bacteria, one or more media for the bacteria to grow on, a suspension bed utilizing an upflow clarifier, aeration (for aerobic systems), anaerobic processes, etc. In addition, water and nutrients may sustain the bacteria via the wastewater. Chemicals may be added to the treatment system for optimizing bacterial consumption of the constituents in the wastewater and removal of wastewater constituents. Water discharged from the mineral removal system 104 may be reused in a building, drained into the soil, etc.

Further, in another embodiment, the mineral removal system 104 may include a reverse osmosis treatment system. Reverse osmosis is the process of hydraulically forcing a solvent through a filter that retains the solute on one side and allows the pure solvent to pass to the other side. Reverse osmosis treatment allows only water molecules to pass through a filter, leaving treated water free of minerals and solids. The treated water preferably contains no minerals, bacteria or viruses, or other constituents of concern. Additionally, the effluent from the mineral removal system 104 may contain no more than 3 parts per million (ppm) of any material other than water and air. Further, the effluent from the mineral removal system 104 may also have a Biological Oxygen Demand (BOD), Total Suspended Solids (TSS), Total Dissolved Solids (TDS), Total Nitrate (TN), and/or salt levels less than 3 mg/l. In addition, a micron filter may be used to treat the water before it enters the mineral removal system. Both the reverse osmosis system and the micron filter may include backflush systems to dispose of filtered solids.

In one embodiment, the wastewater treatment system may include a denitrification process. Denitrification is the process of reducing nitrate and nitrite, highly oxidized forms of nitrogen and organic nitrogen available for consumption by many groups of organisms, into gaseous nitrogen, which is far less dangerous or toxic to life forms but makes up the bulk of our atmosphere. Denitrification takes place under special conditions in both terrestrial and marine ecosystems. In general, it occurs when oxygen (which is a more favorable electron acceptor) is depleted, and bacteria turn to nitrate in order to respire organic matter. Because our atmosphere is rich with oxygen, denitrification only takes place in some soils and groundwater, wetlands, poorly ventilated corners of the ocean, and in seafloor sediments. In the current embodiment, the denitrification process receives water via an inlet pipe, treats the water through denitrification, and discharges treated water through an outlet pipe.

In another embodiment, a prefilter is present. The mineral removal system 104 or settling tank 102 may include the prefilter. A prefilter may allow for submicron to several micron filtration and may remove substantially all solids from the water prior to the water reaching the reverse osmosis system.

In yet another embodiment, one or more control panels may be utilized in the wastewater treatment system in order to assist in the operation of the settling tank 102 and the mineral removal system 104. The control panels may comprise one or more of a computer dial-up modem, monitor, telephone auto dialer, data recording device, equipment controls, and time controls. The control systems may heavily depend on one or more carefully developed control strategies and sensors.

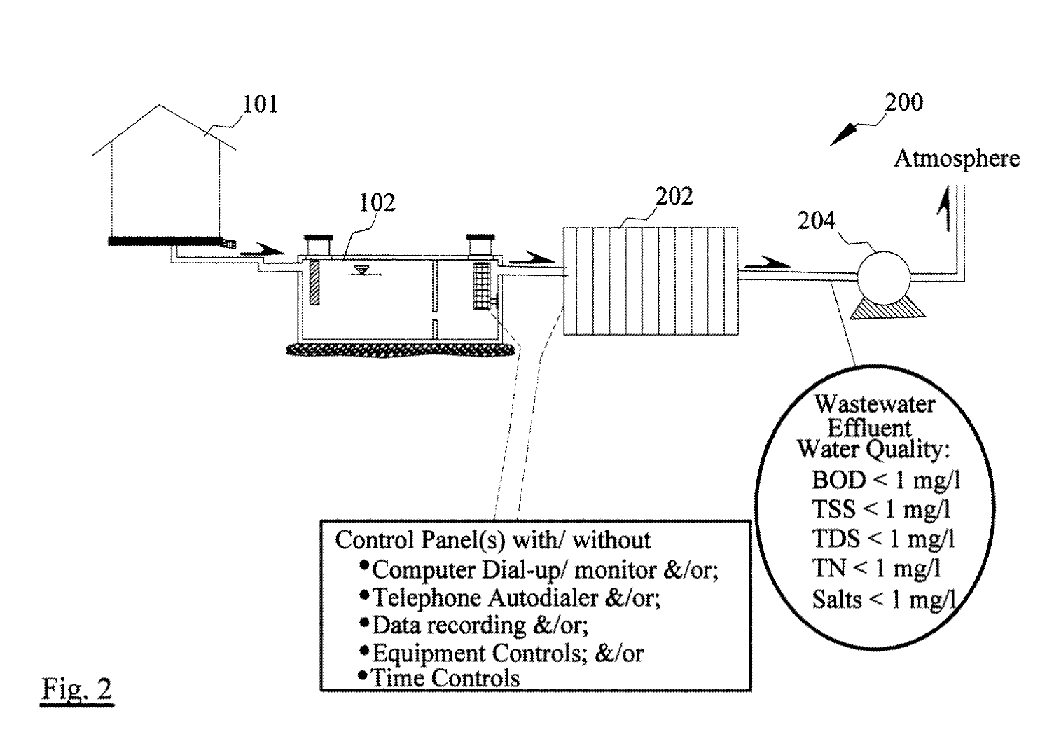

FIG. 2 is a system diagram of a wastewater treatment system 200 in accordance with another embodiment of the present invention. As an option, the system 200 may be implemented in a similar context to the architecture and environment of FIG. 1. Of course, however, the system 200 may be carried out in any desired environment.

As shown in FIG. 2, treated water is received by a vaporization system 202 from the settling tank 102. In an alternate embodiment, the wastewater may be further treated, processed, pumped, etc. before being received by the vaporization system 202. The vaporization system 202 converts the treated water received into water vapor. The effluent from the vaporization system 202 preferably contains no more than 3 parts per million (ppm) of any material other than water and air, though the levels could be higher or lower. Further, the effluent from the mineral removal system 104 may also have a Biological Oxygen Demand (BOD), Total Suspended Solids (TSS), Total Dissolved Solids (TDS), Total Nitrate (TN), and/or salt levels less than 3 mg/l.

In an embodiment, the vaporization system 202 may evaporate water in a vacuum utilizing one or more flash tubes. Flash tubes preheat liquid and subject it to a pressure closer to (relative to ambient air pressure), at, or below its vapor pressure, causing boiling or flashing to occur more rapidly or instantaneously. The heat used by the system for heating the water in this embodiment may come from a heating mechanism included in the vaporization system. Suitable heating mechanisms may include a solar heater, electrical heater, microwave emitter, and combustion heater, where the combustion may be from solid, liquid, or gas fuel. Further, methane may be produced from an anerobic process in the settling tank 102 or treatment system 104 and may be used to power the heating mechanism. In some embodiments, the vaporization system 202 may contain an evaporation chamber which may or may not include flash tubes. The vaporization system 202 may also contain at least one of a level and temperature sensor.

Additionally, a vacuum pump 204 may be included in or may be separate from the vaporization system 202. The vacuum pump 204 may create a vacuum in the evaporation chamber of the vaporization system, and may also receive and discharge water vapor coming from the vaporization system. The vacuum pump may remove gas molecules from a sealed volume in order to leave behind a partial vacuum. In one embodiment, the vacuum pump 204 may create a vacuum in an evaporation chamber. Further, the water vapor may be discharged through an ultraviolet (UV) light, which destroys pathogens, e.g. bacteria, viruses, etc. UV treatment of water vapor may be required in order to obtain regulatory approval. Also, a discharge pipe may receive water vapor from the vacuum pump 204 and emit the water vapor into the atmosphere. Condensation in the discharge pipe may be disposed of in a variety of ways, e.g. by being treated with UV light and discharged into soil, being pumped into a storage tank, passed back into the vaporization system 202, etc.

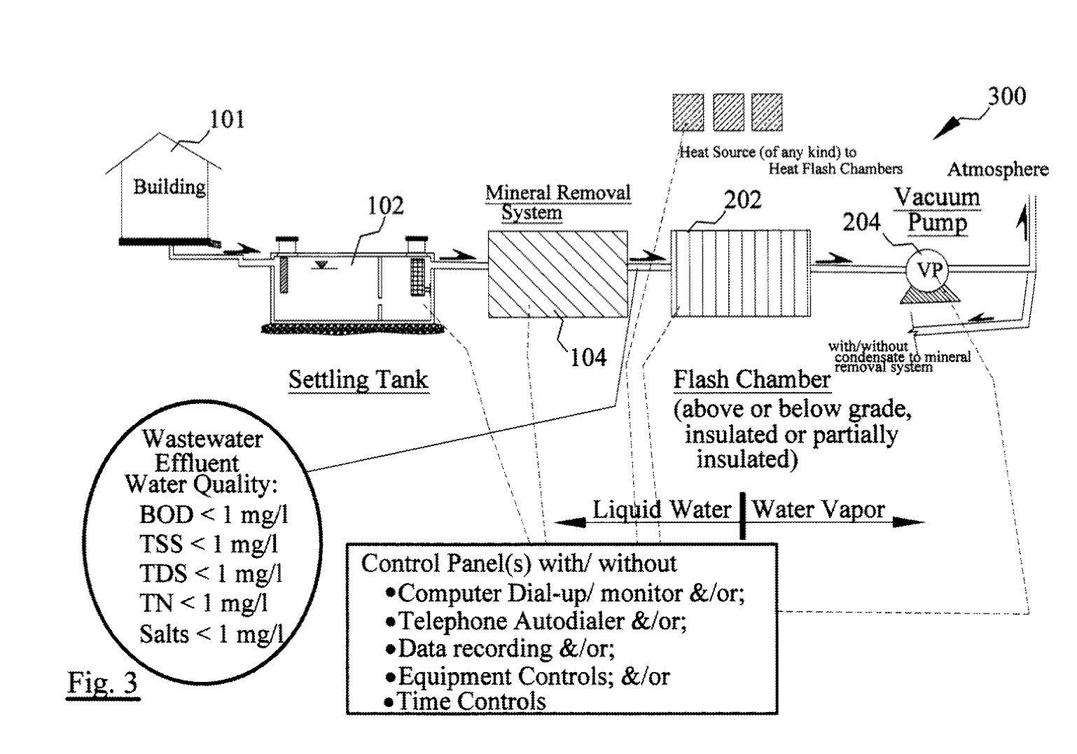

FIG. 3 is a system diagram of a wastewater treatment system 300 in accordance with yet another embodiment of the present invention. As an option, the system 300 may be implemented in the context of portions of the architecture and environment of FIGS. 1 and/or 2. Of course, however, the system 300 may be carried out in any desired environment.

As shown in FIG. 3, a settling tank 102 receives wastewater, where it is treated. Additionally, a mineral removal system 104 receives treated water from the settling tank 102 and removes at least some of the minerals from the treated water. Further, the mineral-reduced water from the mineral removal system 104 is received by the vaporization system 202. The mineral-reduced wastewater is vaporized by the vaporization system in a manner similar to that described in FIG. 2. Also, a vacuum pump 204 receives the water vapor from the vaporization system 202 and discharges the water vapor.

Scaling occurs when liquid containing minerals undergoes a change in at least one of temperature and pressure, and minerals in the liquid are deposited as a result. For example, scaling from minerals in wastewater may result in minerals adhering to the interior of the vaporization system 202. Scaling may have certain effects, e.g., reduced system effectiveness, costly cleaning, structural damage, system failure, etc. By vaporizing mineral-reduced wastewater produced by the mineral removal system 104 instead of treated water with a higher mineral content, the amount of scaling occurring in the vaporization system 202 is significantly reduced or eliminated.

In another embodiment, other options may be used to address scaling. For example, tube settlers, clarifiers, e.g. electro-magnetic clarifiers, coagulants, and any other type of mineral removal system, may be included in the mineral removal system 104 in order to filter and remove minerals and other damaging sediment in water. An ion exchange or chemical addition or mineral wash, such as an acid wash, may also be used to remove scaling from the vaporization system 202. Further, a replaceable vaporization system 202 may also be used to address scaling issues.

In other embodiments, scale (from minerals) is periodically removed from the vaporization system. This may be performed as needed, on a regular schedule, etc.

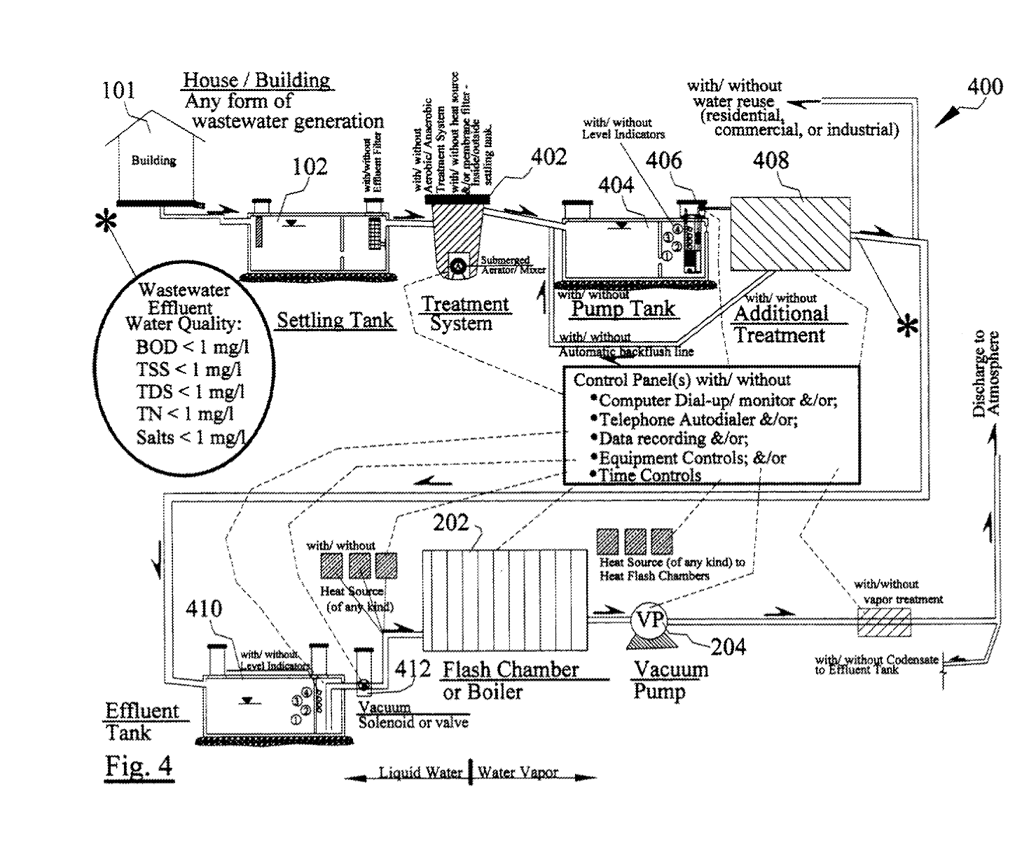

FIG. 4 is a system diagram of a wastewater treatment system 400 in accordance with yet another embodiment of the present invention. As an option, the system 400 may be implemented in the context of the architecture and environment of FIGS. 1, 2 and/or 3. Of course, however, the method 300 may be carried out in any desired environment.

As shown in FIG. 4, wastewater is received by a settling tank 102. Additionally, treated water discharged from the settling tank 102 is received by a treatment system 402. The treatment system 402 provides further treatment of the water through aerobic or anerobic treatment. The water treatment may include the use of one or more of bacteria, one or more media for the bacteria to grow on, a suspension bed utilizing an upflow clarifier, aeration (for aerobic systems), and anaerobic processes. In addition, water and nutrients may sustain the bacteria via the wastewater. Chemicals may also be added to the treatment system for optimizing and removal of constituents via bacterial consumption or other means in wastewater.

In one embodiment, the treatment system 402 may contain one or more of a submerged aerator, a submerged mixer, a heat source, and any other device which would improve the efficiency of the aerobic or anerobic treatment. The treatment system 402 may also comprise a membrane filter to further filter the water. Additionally, in one embodiment the treatment system 402 may be located inside the settling tank 102.

Further, treated water discharged from the treatment system 402 is received by a pump tank 404. The pump tank 404 stores treated water and regulates water flow for the other treatment modules. A pump in the pump tank 404 pumps water (via a control system) to a micron filter 406. The micron filter 406 is a self-cleaning filter which may have 0.1 to 10 micron solid filtering capabilities. Backwash water from the micron filter is placed back in the pump tank. In one embodiment, the pump tank 404 contains floats that work with a control system to pump the treated water under pressure. This pumping may be in response to the demands of a control strategy.

Additionally, water discharged from the pump tank 404 and filtered by the micron filter is received by an additional treatment system 408. The additional treatment system 408 may add one or more chemicals to condition the water, and may also perform a mineral removal process similar to that performed by mineral removal system 104. In one embodiment, an automatic backflush line may be coupled to the additional treatment system.

Further, water discharged from the additional treatment system 408 is received by the effluent tank 410, where it is stored and prepared for sending to the vaporization system 202. Optionally, the effluent tank 410 may contain the control mechanisms for the entire system 400. The control mechanisms may comprise a computer with dial-up capabilities, a monitor, a telephone autodialer, a data recording device, equipment controls, and time controls. In addition, some of the controls may allow the controlled feeding of water to the vaporization system 202. The control systems may heavily depend on one or more carefully developed control strategies and sensors.

Additionally, water from the effluent tank 410 passes through a vaporization valve 412 and into the vaporization system 202. The vaporization valve 412 opens to allow water into the vaporization system 202 while under a vacuum. The valve closes when sufficient water is in the vaporization system 202. The vacuum created by the vacuum pump 204 may draw the water into the vaporization system 202 when the vaporization valve 412 is open. Additionally, the vaporization valve 412 may be air tight when closed.

The control strategy of the vaporization valve 412 may be operated by the water level in the tube connecting to the vaporization system 202 and the water levels in the effluent tank 410. Water flowing through the vaporization valve 412 is then received by the vaporization system 202, which converts the treated water received into water vapor in a manner similar to the vaporization system 202 in FIG. 2. The water vapor produced by the vaporization system 202 is received by a vacuum pump 204, which discharges the water vapor in a manner similar to the vacuum pump 204 in FIG. 2.

In one embodiment, one or more of the systems illustrated may be powered by the use of solar energy and solar panels. Solar energy may also supplement, or serve as a backup to, a system utilizing gas or electric power.

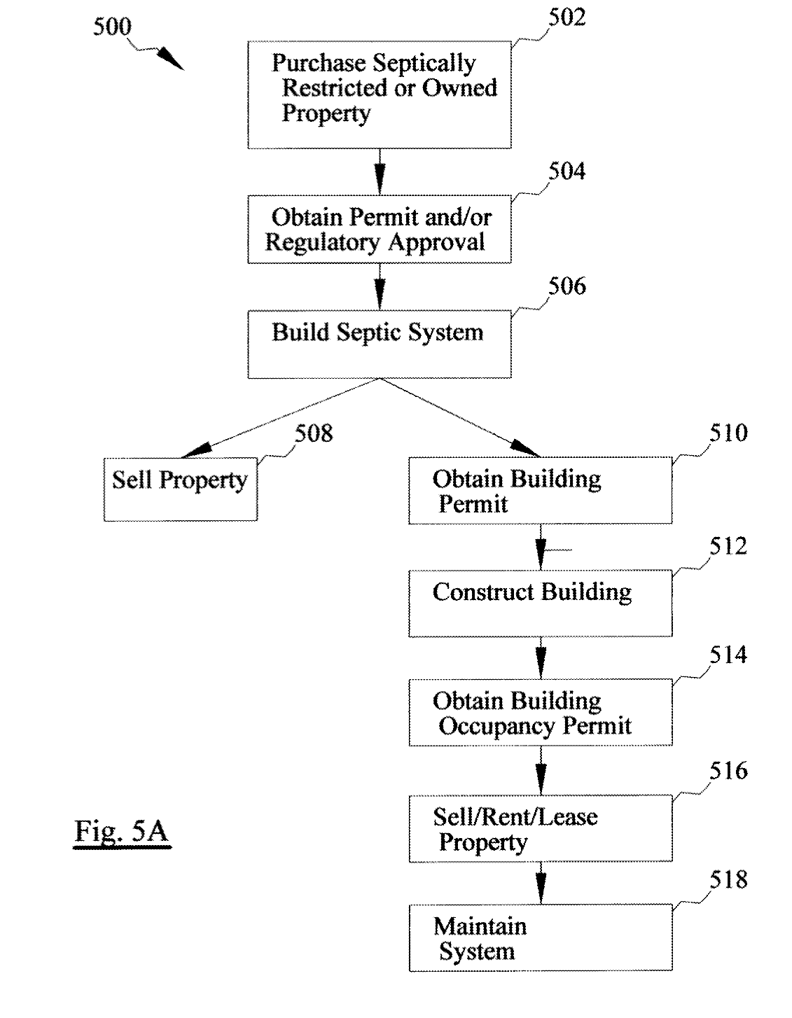

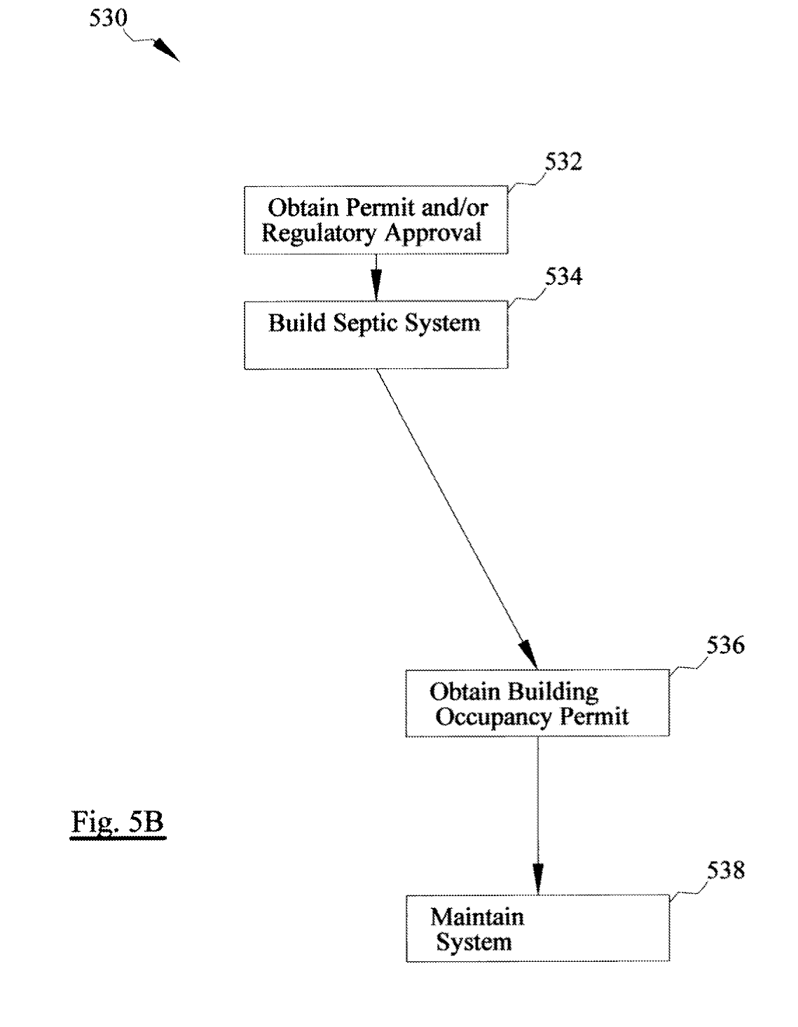

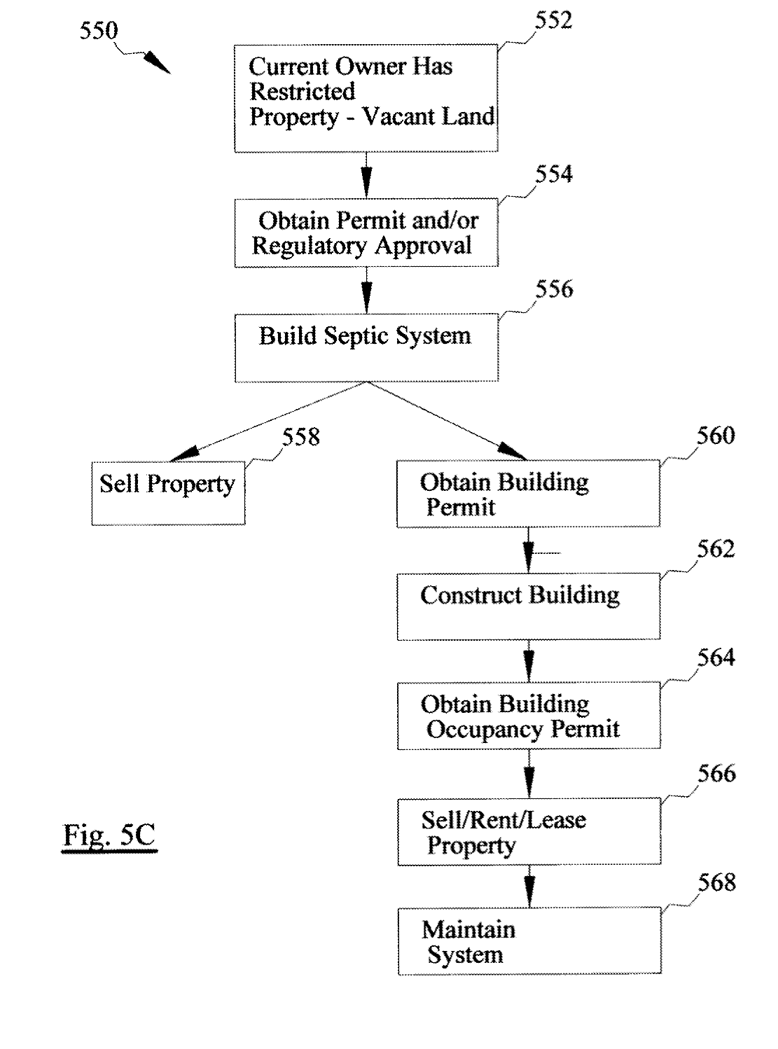

FIG. 5A depicts a flow diagram of a method 500 for applying a wastewater treatment system to the purchase of real estate. As an option, the method 500 may be implemented in the context of the architecture and environment of FIGS. 1, 2, 3, and/or 4. Of course, however, the method 500 may be carried out in any desired environment. The steps in method 500 need not be carried out in any particular order.

In optional step 502 septically restricted property is purchased. The restriction may disallow effluent discharge into the land or surrounding water, for example. This property may be purchased at a price much lower than similar property where a no septic restrictions exist. The land may also be viewed as useless to the seller since the seller is unable to obtain a septic permit for the property. Additionally, the original owner may lose the property in foreclosure, and the property may then be purchased at a foreclosure sale, usually at a discounted price. In another embodiment, the original owner may implement the method 500 after they are unable to obtain a septic permit.

In step 504, a permit and regulatory approval for a septic system are obtained based on the teachings herein, which may include some or all of the technology illustrated in FIGS. 1-4 above. This technology may enable land that was originally not suitable for human occupancy under older methods to now be allowed to be developed with buildings suitable for human occupancy. For example, septic systems which result in effluent entering the surrounding soil or surrounding water may be disallowed in certain areas. However, utilizing the above technology, a septic system which results in effluent being converted to vapor and released into the atmosphere instead of the soil or surrounding water may be allowed.

In step 506, the septic system is built based on the teachings herein, which may include some or all of the technology illustrated in FIGS. 1-4 above. Once the septic system is constructed, the property may be sold, rented, or leased in step 508. Since the property now has a functional septic system as well as a valid septic permit and approval, the value of the property may be significantly higher than the purchase price paid for the septically restricted property, which may result in a large profit.

Alternately, in step 510 a building permit may be obtained for the property. Additionally, if a building permit is chosen to be obtained, in step 512 a building is constructed for human occupancy. Further, in step 514 a building occupancy permit is obtained, and in step 516 the property may be sold, rented, or leased. Also, in step 518 the septic system based on the above technology is maintained as long as human use is involved with the purchased property. This may insure that the property maintains suitable for human occupancy from a septic standpoint.

FIG. 5B depicts a method 530 for applying a wastewater treatment system to approval to build on real estate. In one illustrative scenario, an existing building owner may have a restricted or failed septic system. In another example, the property may be bare land, for which septic system approval is not otherwise available absent a system as described herein. In a further example, the owner of a building may want to expand the size of the building, but cannot obtain septic approval using heretofore known systems. In step 532, a permit and/or regulatory approval to build a septic system is obtained. In step 534, the septic system is built. In step 536, an occupancy permit is obtained. In optional step 538, the system is maintained.

FIG. 5C depicts a flow diagram of a method 550 for applying a wastewater treatment system to the purchase of real estate. As an option, the method 550 may be implemented in the context of the architecture and environment of FIGS. 1, 2, 3, 4, 5A and/or 5B. Of course, however, the method 550 may be carried out in any desired environment. The steps in method 550 need not be carried out in any particular order.

In optional step 552 it is determined that septically restricted property is owned. Such property may be vacant land. The restriction may disallow effluent discharge into the land or surrounding water, for example. This property may be valued at a price much lower than similar property where a no septic restrictions exist. The land may also be viewed as useless to the seller since the seller is unable to obtain a septic permit for the property. In another embodiment, the original owner may implement the method 550 after they are unable to obtain a septic permit.

In step 554, a permit and regulatory approval for a septic system are obtained based on the teachings herein, which may include some or all of the technology illustrated in FIGS. 1-4 above. This technology may enable land that was originally not suitable for human occupancy under older methods to now be allowed to be developed with buildings suitable for human occupancy. For example, septic systems which result in effluent entering the surrounding soil or surrounding water may be disallowed in certain areas. However, utilizing the above technology, a septic system which results in effluent being converted to vapor and released into the atmosphere instead of the soil or surrounding water may be allowed.

In step 556, the septic system is built based on the teachings herein, which may include some or all of the technology illustrated in FIGS. 1-4 above. Once the septic system is constructed, the property may be sold, rented, or leased in step 558. Since the property now has a functional septic system as well as a valid septic permit and approval, the value of the property may be significantly higher than the purchase price paid for the septically restricted property, which may result in a large profit.

Alternately, in step 560 a building permit may be obtained for the property. Additionally, if a building permit is chosen to be obtained, in step 562 a building is constructed for human occupancy. Further, in step 564 a building occupancy permit is obtained, and in step 566 the property may be sold, rented, or leased. Also, in step 568 the septic system based on the above technology is maintained as long as human use is involved with the purchased property. This may insure that the property maintains suitable for human occupancy from a septic standpoint.

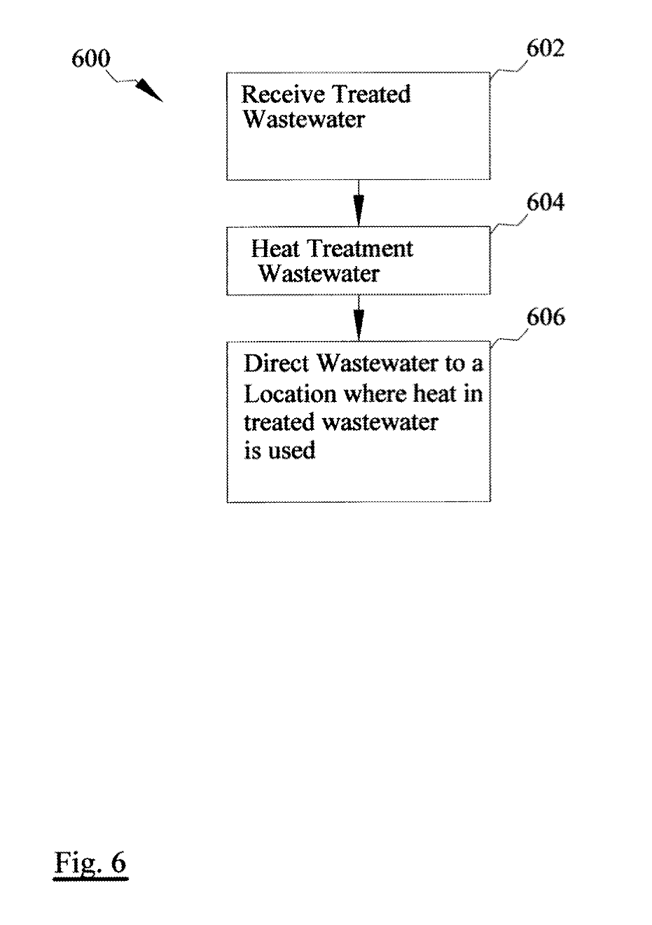

FIG. 6 illustrates a method 600 of heating. In step 602, treated wastewater is received. In step 604, the treated wastewater is heated using any known method, including those set forth above. In step 606, the wastewater is directed to a location where heat in the treated wastewater is used. Examples of uses of heated wastewater include heating water for home use, radiant heating, biological processes, floor heating, building heating, etc.

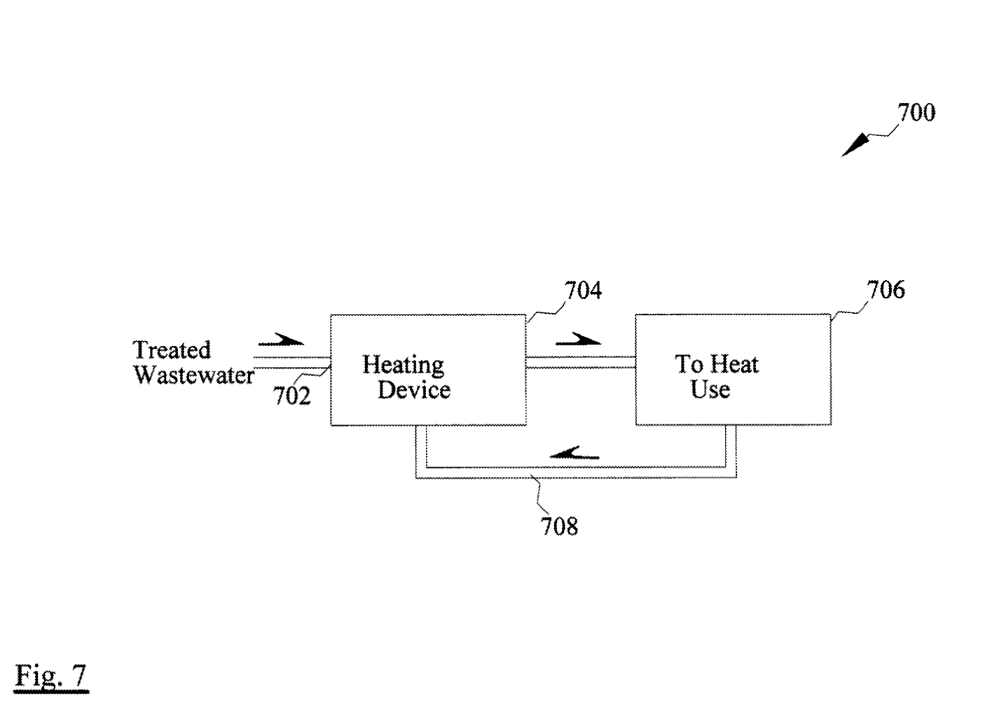

FIG. 7 depicts a system 700 in which the method of FIG. 6 may be implemented. As shown in FIG. 7, treated wastewater enters the system at point 702. A heating device 704 such as the vaporization system (described above), boiler, heat exchanger, etc. heats the treated wastewater. As implied from the types of heating devices, the treated wastewater can be simply heated, or can be vaporized. The heated wastewater is then directed to a location 706 where the heat energy therein is used. A recycle line 708 may be included to return cooled wastewater to the heating device 704.

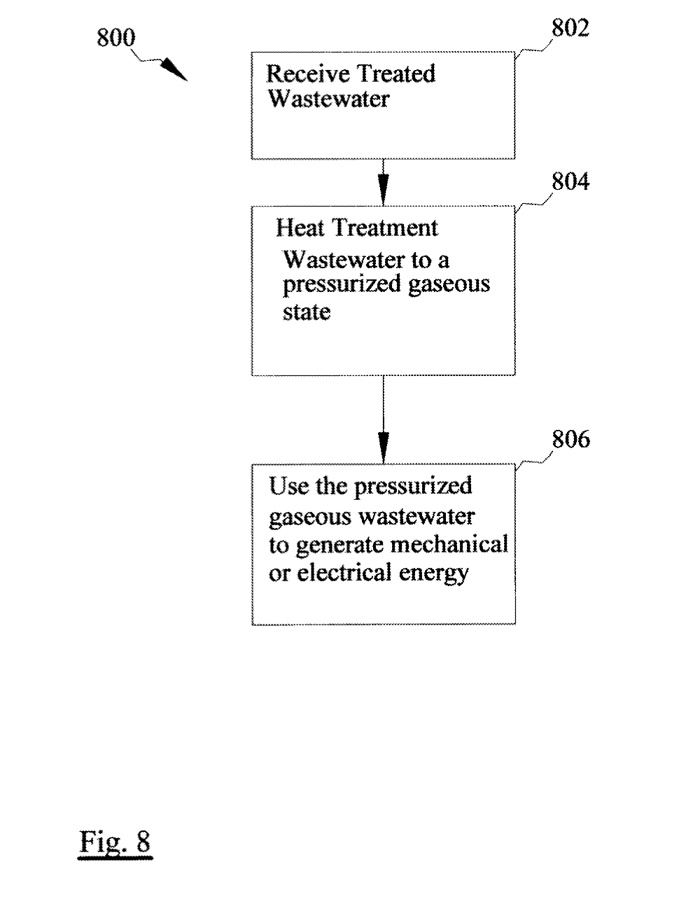

FIG. 8 illustrates a method 800 for converting energy. In step 802, treated wastewater is received. In step 804, the treated wastewater is heated to a pressurized gaseous state. Again, the treated wastewater may be heated using any known method, including those set forth above. In step 806, energy in the pressurized gaseous wastewater is converted to another form of energy such as mechanical energy, electrical energy, or both. Examples in which mechanical energy may be generated and/or used is driving turbines, power motorized equipment such as pumps, etc. Electrical energy may be generated in traditional fashion, for example, with the pressurized gaseous wastewater driving a turbine coupled to an electrical generator.

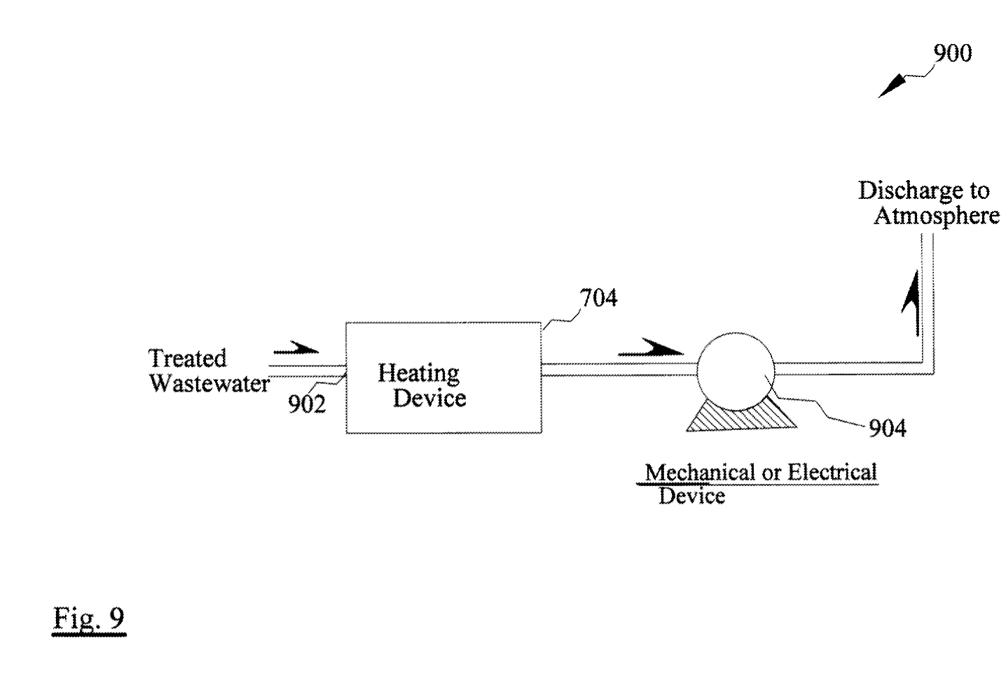

FIG. 9 depicts a system 900 in which the method of FIG. 8 may be implemented. As shown in FIG. 9, treated wastewater enters the system at point 902. A heating device 704 such as the vaporization system (described above) or modification thereof, boiler, heat exchanger, etc. heats the treated wastewater to a pressurized gaseous state. The pressurized gaseous wastewater is directed to a mechanical device or electricity-generating device, the pressurized gaseous wastewater driving the respective device through conversion of energy therefrom (e.g., kinetic, heat, pressure, potential, etc.) to another form (mechanical, electrical, etc.).

The present description is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

It should also be understood that the techniques presented herein might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

Various embodiments can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

What is claimed is:

1. A wastewater treatment system, comprising:
a settling tank for receiving wastewater;
a mineral removal system receiving water from the settling tank, the mineral removal system being for removing at least some of the minerals from the water; and
a vaporization system receiving water from the mineral removal system, the vaporization system being for vaporizing the water.

2. The wastewater treatment system of claim 1, wherein the settling tank contains at least one of microbes and enzymes for biologically treating the wastewater.

3. The wastewater treatment system of claim 1, further comprising a secondary treatment system receiving water from the settling tank, the mineral removal system receiving water from the secondary treatment system, the secondary treatment system utilizing biological decomposition to remove solids.

4. The wastewater treatment system of claim 1, wherein the mineral removal system includes a reverse osmosis system.

5. The wastewater treatment system of claim 4, wherein the mineral removal system includes a prefilter for removing substantially all solids from the water prior to the water reaching the reverse osmosis system.

6. The wastewater treatment system of claim 1, wherein the effluent from the mineral removal system contains no more than 3 parts per million of any material other than water and air.

7. The wastewater treatment system of claim 1, wherein the mineral removal system includes at least one of a clarifier, a tube settler, an electro-magnetic clarifier, ion exchange, and chemical addition.

8. The wastewater treatment system of claim 1, wherein the vaporization system includes an evaporation chamber, and a vacuum pump for creating a vacuum in the evaporation chamber.

9. The wastewater treatment system of claim 8, wherein the vacuum created by the vacuum pump draws the water into the evaporation chamber through an open solenoid or valve, the solenoid or valve being air tight when closed.

10. The wastewater treatment system of claim 1, wherein the vaporization system includes a heating mechanism for heating the water.

11. The wastewater treatment system of claim 10, wherein the heating mechanism is selected from a group consisting of a solar heater, electrical heater, microwave, emitter, and combustion heat.

12. The wastewater treatment system of claim 1, wherein the effluent from the vaporization system contains no more than 1 parts per million of any material other than water and air.

13. A septic water treatment system, comprising:
a settling tank for receiving septic water;
a mineral removal system receiving water from the settling tank, the mineral removal system being for removing at least some of the minerals from the water.

14. The septic water treatment system of claim 13, wherein the effluent from the mineral removal system contains no more than 3 parts per million of any material other than water and air.

15. A septic water treatment system, comprising:
a settling tank for receiving wastewater;
a vaporization system receiving water from the settling tank, the vaporization system being for vaporizing the water in the presence of a vacuum, the vacuum being at least 0.15 atmospheres below an air pressure of an environment located at an outlet of the vaporization system.

16. The wastewater treatment system of claim 15, wherein the vaporization system includes an evaporation chamber being isolated from the environment located at the outlet of the vaporization system.

17. The wastewater treatment system of claim 15, wherein scale is periodically removed from the vaporization system.
